(19) United States
(12) Patent Application Publication
(10) Pub. No.: US 2017/0355520 A1
(43) Pub. Date: Dec. 14, 2017

(54) Container with Liner Slots

(71) Applicant: United Comb & Novelty Corporation, Leominster, MA (US)

(72) Inventors: Sean Curran, Leominster, MA (US); Ronald Audet, North Smithfield, RI (US)

(21) Appl. No.: 15/492,709

(22) Filed: Apr. 20, 2017

Related U.S. Application Data
(60) Provisional application No. 62/347,510, filed on Jun. 8, 2016.

(51) Int. Cl. B65F 1/06; B65D 21/02

(52) U.S. Cl. CPC B65F 1/068; B65D 21/0233; B65F 1/06; B65F 2250/114; B65F 2001/061

(57) ABSTRACT

A one-piece, open top container with two or more parabola-shaped securing slots for securing handled bags used as liners.

### CROSS-REFERENCE TO RELATED APPLICATION

This application claims benefit from U.S. Provisional Patent Application No. 62/347,510, filed on Jun. 8, 2016, the contents of which are incorporated herein by reference.

### BACKGROUND

This disclosure relates to a container with slots with which to secure handled plastic bags of the type often used in grocery stores. These handled bags are plentiful and are often simply discarded after they are used by consumers to transport products from retail stores to homes. Handled bags have historically been used to line containers, however they often fall into the containers along with the contents as they are not secured to the top or rim of containers.

### SUMMARY

Featured in this disclosure is a container with liner slots which are designed to secure the handles of handled plastic bags, used as liners to keep the container clean, so that the bags will not be pulled into the container along with the container contents. It also allows the plastic bag to maintain the shape of the container so the contents may be emptied from the bag easily if one would like to reuse the plastic bag as the container liner. The unique slots in the container allow the user to easily remove a filled plastic bag from the container to dispose of it or otherwise, allowing a new plastic bag/liner to be placed within the container and held in place by the liner slots.

All examples and features mentioned below can be combined in any technically possible way.

Embodiments may include a one-piece molded container with a generally rectangular open top connecting two sets of opposing surfaces, a front, a back and two sides. Other shaped containers may be utilized as long as they may host the opposing handles of a handled plastic bag, much like one provided by grocery and retail stores. The container features a mechanism which may easily and reliably secure and release handled plastic bags when they are used as a liner for the container. This allows the container to collect waste or other materials without needing to be cleaned, while also providing a use for handled plastic bags which are often abundantly available. Handled plastic bags are widely used by consumers to line containers, but they often simply overlap the top rim of the container and are easily pulled into the container when trash, or other items, are deposited within the bag. The subject invention features slots in the sides of the container, through which plastic bag handles may be easily inserted and held, while also providing very simple removal of the handles/bag. Also, there are no protruding pegs, hooks, or the like on the external surfaces of the container. Therefore, there are no external protrusions which can be broken or which can inflict scratches upon passing users. Also, the shape of the slots are smooth and continuous, with no sharp edges or points on which a user may be injured while installing or removing a bag. In addition, the liner slots provide aesthetic accents to the exterior surface of the container, while also providing the function of securing plastic bag handles. Therefore, the container provides for the secure, safe, and subtle temporary attachment of handled plastic bags being used as liners.

Embodiments may feature liner securing slots which resemble the smooth contour of a parabola with a preferred shape of a sinewave that is 2π radians to 3π radians in total length, with a single lowest point or lower portion at its lateral center, and an upper portion on either side of the lower portion. The lower portion is lower than the upper portions with respect to the upper rim of the container, the lower portion located farther from the upper rim than the upper portions. Each handle of a plastic bag may be inserted from the exterior of a container, through the lower portion of the liner slot, and into the interior of the container. The handle is secured by pulling each side of the handle upward and away from the central lower portion of the slot, toward the upper portions of the slot, adjacent to the lower portion of the slot. The lower portion of the liner slot creates a downward tongue of container material around which the plastic bag handle wraps when pulled upward by the user on either side of the liner slot. Once the handle is secured behind the tongue, above the lower portion of the liner slot, the body of the plastic bag may be inserted into the interior of the container. The downward force of the bag into the container interior further secures the bag handles in place behind the tongue above the lower portion of the liner slot. An installed plastic bag rests within the interior of the container with the bag handles reaching over the upper rim of the container and secured in place by the liner securing slots located appropriately, each opposing another on the container.

When a plastic bag is installed within a container, as described in the above embodiment, each handle protrudes from the two upper portions of each slot. To release the handles from the securing mechanism, and therefore release the bag from the container, one must simply move the bag handles protruding from the slot upper portions toward each other so the handle will release from the slot lower portion. There are no objects from which the handles must be unhooked or disconnected, making the use of the container very easy. Also, the tongue is rounded due to its parabola shaped lower portion of the slot, therefore there are no corners or edges or points in the slot that the plastic bag handles must overcome in order to be released. The parabola shaped lower portion of the slot creates a shape of the tongue that keeps the bag handles held in place when the bag is installed within the container. Its shape also provides very simple removal of the bag handles when each side of each handle is moved toward the other of the same handle.

Embodiments may include one of the following features, or any combination thereof. The container for use with plastic bags may also include a plurality of securing slots throughout the surface of the container, through which plastic bag handles may be inserted and secured. This feature provides flexibility in terms of the sizes of bags which may be utilized with a container. A variety of bag sizes are provided to consumers by retailers and hence the multiple slots allow varied bag sizes to be used as liners. Multiple slots in the container also provide aesthetic accents to the appearance of the container, while maintaining the strength and rigidity of the container.

Embodiments of the container may have a variety of heights, as measured from its bottom to its upper rim, and areas for the open top. Also, the container may have a rectangular open top, a front, a back and two sides. But the container may also be cylindrically shaped or have multiple sides, as long as liner slots in the container oppose each other to host the opposing handles of a handled plastic bag.

An embodiment of the container may comprise one or more liner securing slots which are a variety of lengths. Liner slots may be greater than 3π radians in length as long as at least one lower portion of the slot exists between at least two upper portions of the slot. This creates a necessary tongue which secures, and provides simple release of each plastic bag handle.

### BRIEF DESCRIPTION OF THE DRAWINGS

FIG. 1 is a front perspective view of a container with liner securing slots.

FIG. 2 is a top view thereof.

FIG. 3 is a side view thereof.

FIG. 4 is close-up view of the liner securing slot shown in FIG. 3.

FIG. 5a is a close-up interior view of a liner securing slot of a container, with a handle of a plastic bag secured within the liner slot. FIG. 5b is the same close-up after the bag has been installed within the interior of the container.

FIG. 6 is a perspective side view of a container with plastic bag handles installed within liner securing slots and the plastic bag installed within the container interior.

FIG. 7 is an embodiment of a container with multiple liner securing slots on a side of the container.

FIG. 8 is an embodiment of a container with multiple liner securing slots on the front of the container.

FIG. 9 is an embodiment of a liner securing slot with multiple upper portions and lower portions.

### DETAILED DESCRIPTION

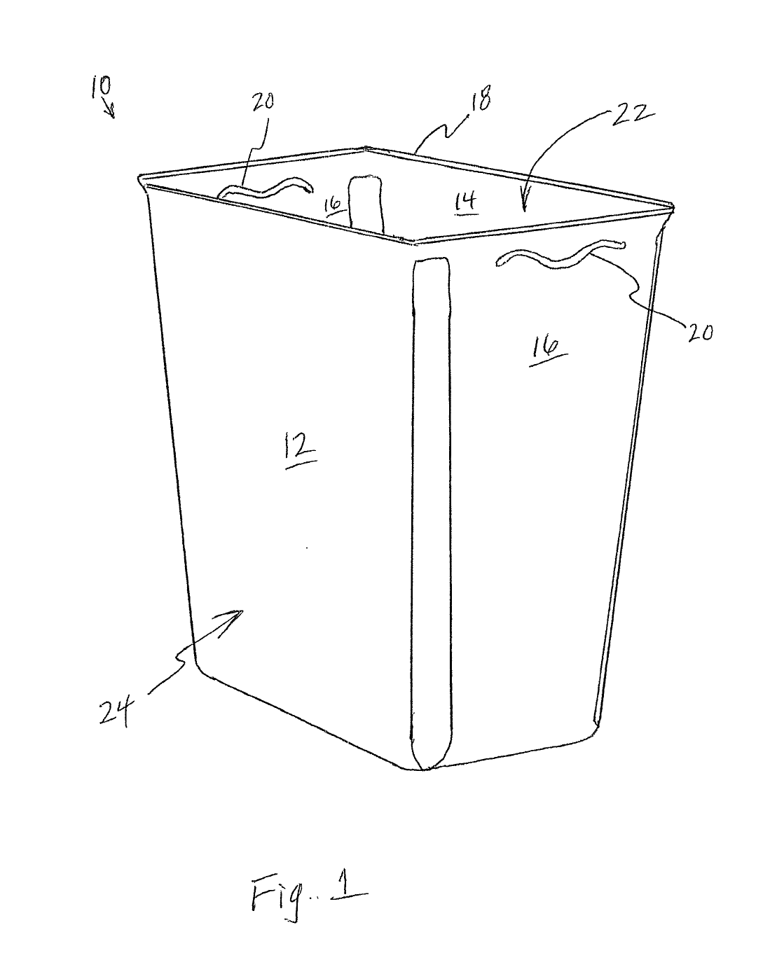

Container 10 in FIG. 1 is preferably a one-piece open top plastic molded container which can be made from any appropriate plastic such as polystyrene, polyethylene, or polypropylene, for example. This perspective view of container 10 features front 12, back 14, sides 16, upper rim 18, and liner securing slots 20. The open top of container 10 has a rectangular shape, although this is one of a variety of possible shapes and sizes of the container. Container 10 has an interior 22 and an exterior 24. Securing slot 20 provides an avenue between interior 22 and exterior 24 so that a handled plastic bag may be secured as a liner within interior 22.

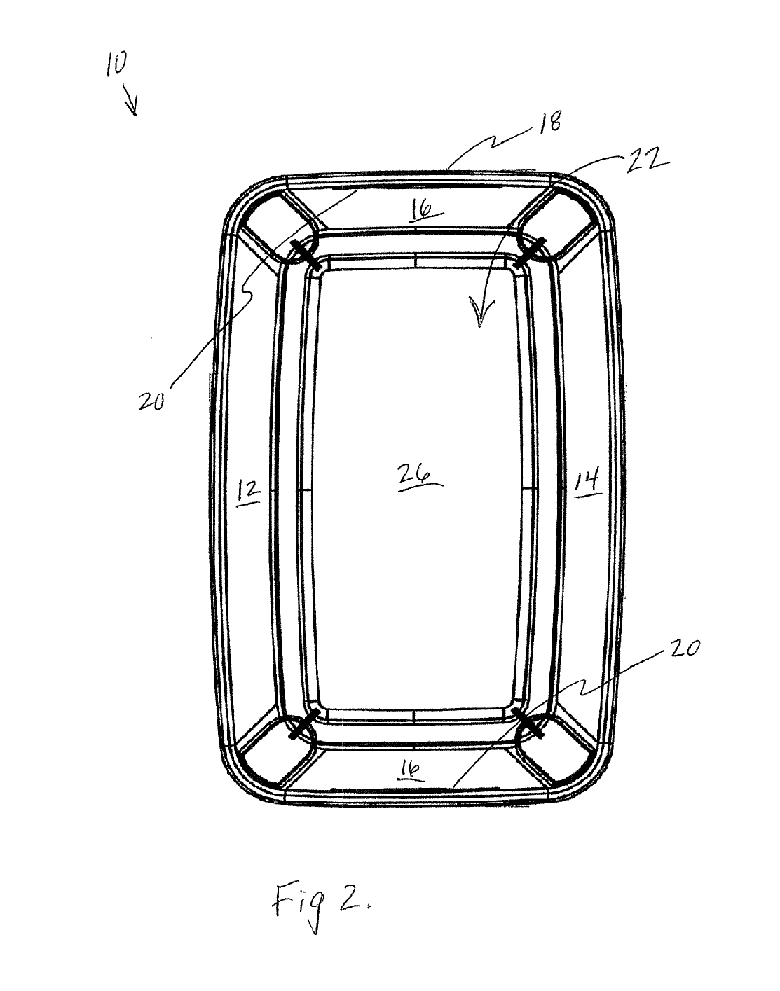

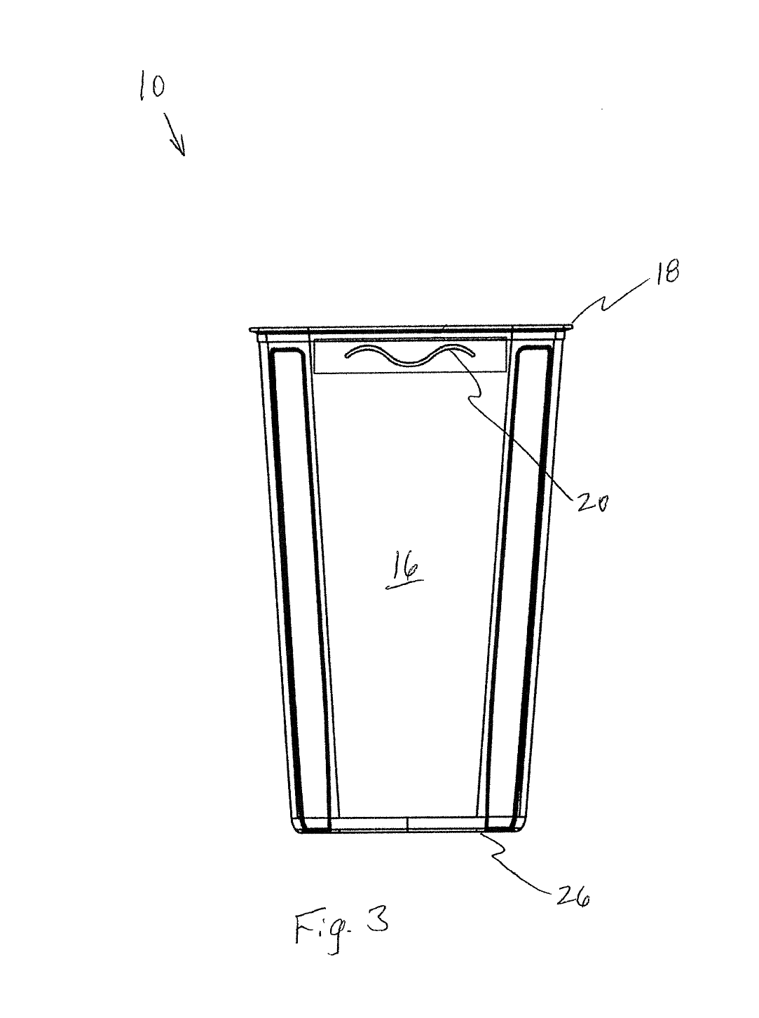

FIG. 2 shows a top view of a container 10 having a front 12, a back, 14, two sides 16, an upper rim 18, and a bottom 26. This interior 22 view of open top container 10 reveals a slim view of liner securing slots 20, each on opposing sides 16 just below upper rim 18.

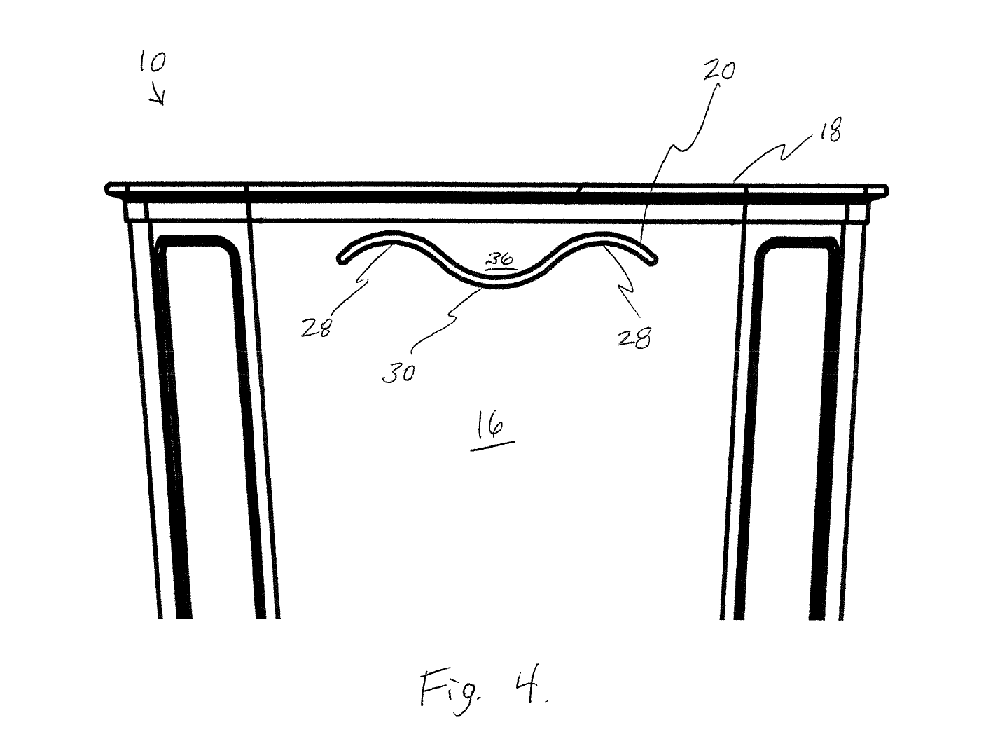

FIG. 3 shows a side view of container 10 with side 16, upper rim 18, liner securing slot 20 and bottom 26 that is smaller in area than the area of the open top circumscribed by upper rim 18, to allow easy nesting of like containers. In this embodiment liner securing slot 20 is located just under upper rim 18 and resembles a sinewave with a length of approximately 3π radians.

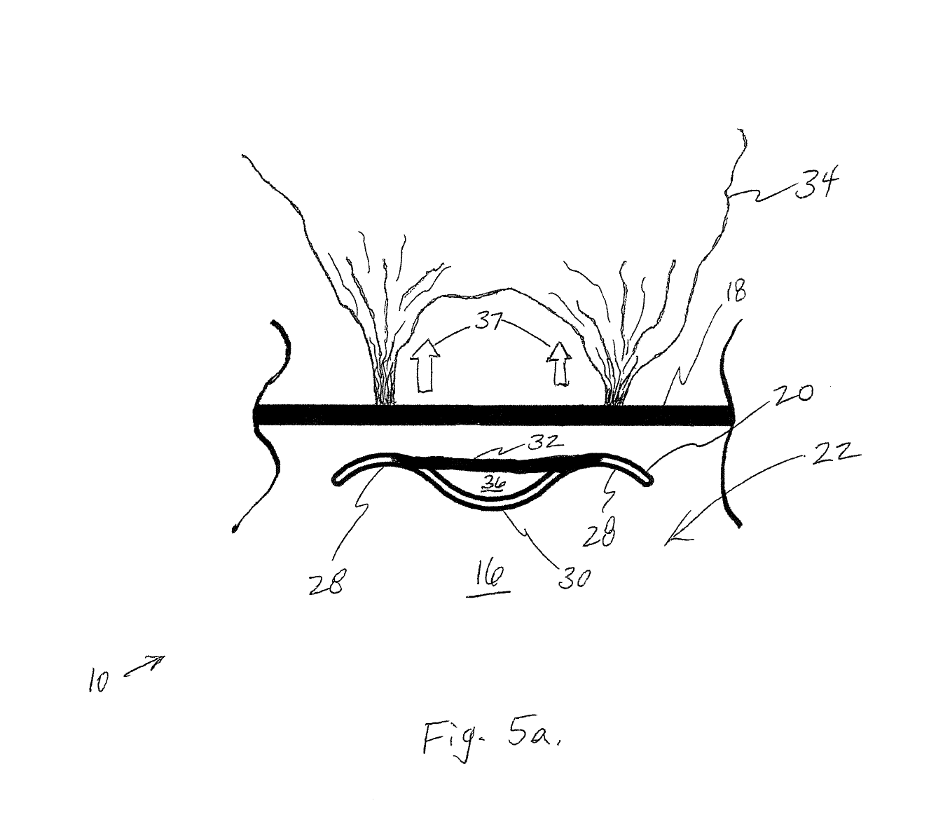

FIG. 4 shows a detailed view of liner securing slot 20 in container 10 from FIG. 3. In this view liner slot 20 can be seen to have a sinewave shape with a length of approximately 3π radians. With respect to upper rim 18, the slot's lateral center is shaped like a parabola with a vertex or lower portion 30. The slot's highest points or upper portions 28 are located on either side of lower portion 30. This sinewave shaped slot 20 through container 10, with its parabola shaped central lower portion 30, creates tongue 36 which is ultimately the mechanism that holds prospective bag handles in place on the container.

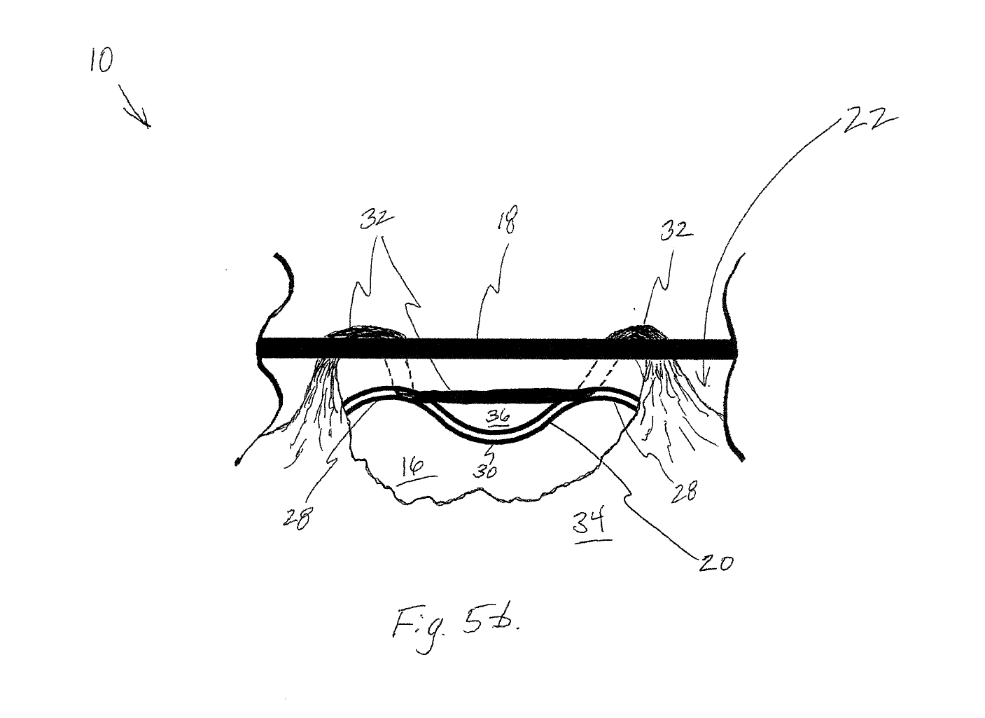

FIG. 5a shows a detailed interior 22 view of liner securing slot 20 on side 16 of container 10, with bag handle 32 looped through slot 20. Handle 32 is initially inserted into interior 22 of container 10 through lower portion 30 of liner slot 20. Then bag 34 is pulled upward in direction 37, pulling handle 32 into slot upper portions 28 and securely behind tongue 36. FIG. 5b shows the same detailed view as FIG. 5a after bag 34 has been pulled over upper rim 18 and into interior 22 of container 10. When bag 34 is pushed into interior 22 of the container, handle 32 is pulled so that it rises farther into upper portions 28 of liner slot 20, thereby further securing handle 32 behind tongue 36.

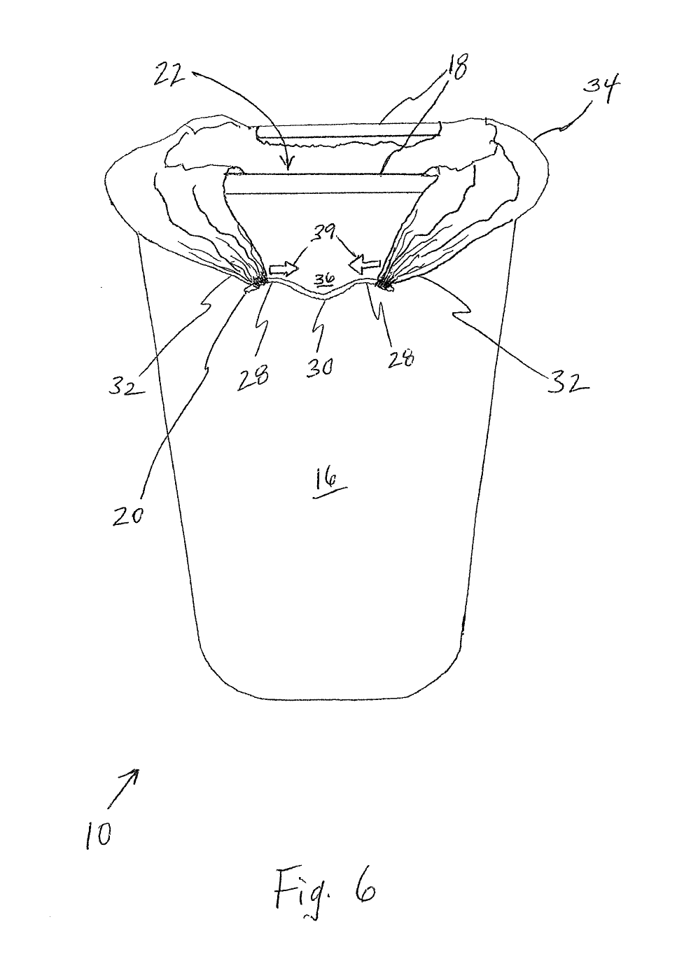

Container 10 is shown in FIG. 6 with bag 34 installed within the container. Bag handles 32 are installed on each side 16 of container 10 through liner securing slots 20 (bag handle, slot, and opposing side of container not shown). Bag handle 32 loops over upper rim 18 and through slot lower portion 30. When the bag in placed within interior 22 of container 10, handle 32 is pulled upward toward upper rim 18 and into slot upper portions 28 of liner slot 20. This holds handle 32 securely behind tongue 36. Bag handle 32 may be easily released from tongue 36 by simply pushing either or both the parts of handle 32, protruding from upper portions 28, toward each other in direction 39. This movement of handle 32 moves it easily to lower portion 30 so that it will come out from behind tongue 36. This simplifies the release of bag 34 because bag handles 32 do not need to be manipulated to “unhook” them from holders, hooks, pins, or obstacles of any kind, greatly simplifying the process of securing and releasing bag 34 from container 10.

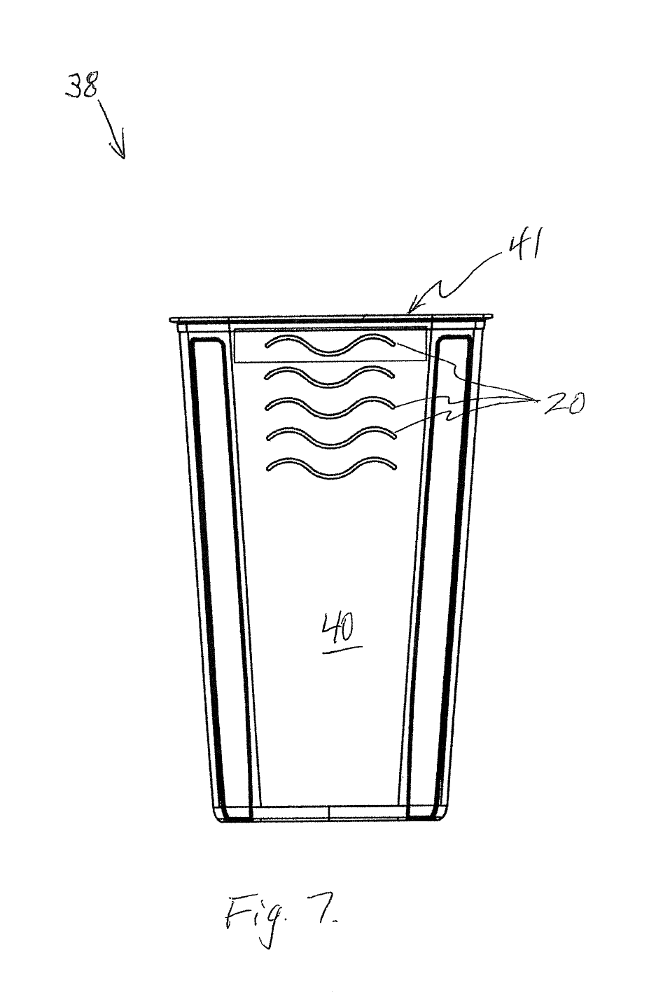

FIG. 7 shows an embodiment of container 38 with multiple liner securing slots 20 on side 40 of the container. There are a variety of bags available from retailers and other sources. Bag sizes and handle lengths may vary significantly, making a single liner securing slot less than adequate for the assortment of bags available. If a bag has a large volume and short handles, one may utilize a liner slot which is closer to upper rim 41. If a bag has a smaller volume and longer handles, it may utilize a liner slot which is a greater distance from upper rim 41.

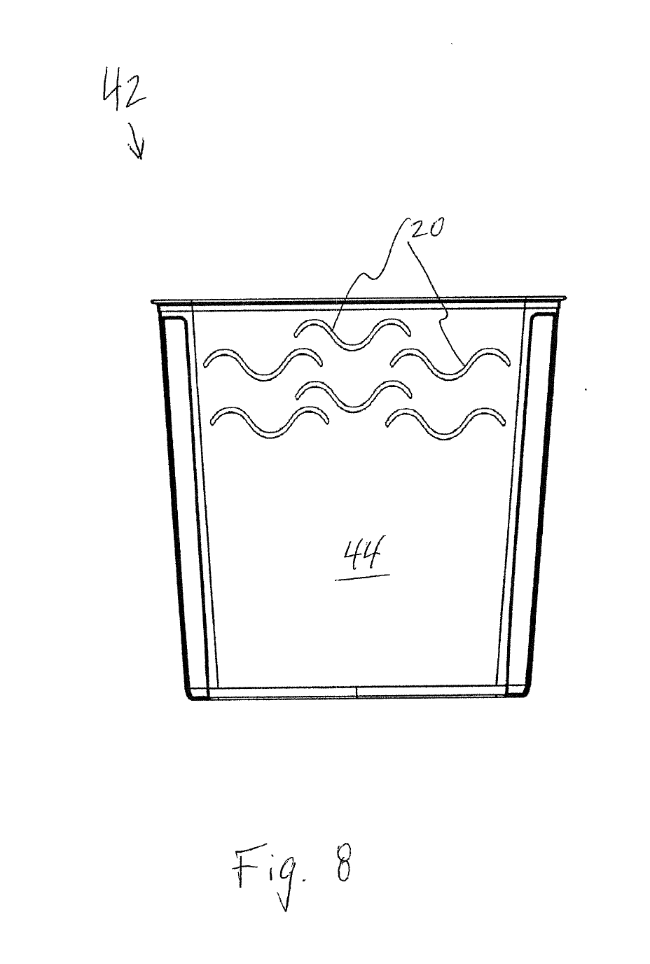

Container 42 shown in FIG. 8 depicts container front 44 featuring multiple liner securing slots 20. The slots may be used to secure a variety of sizes of plastic handled bags while also providing aesthetic features to front 44.

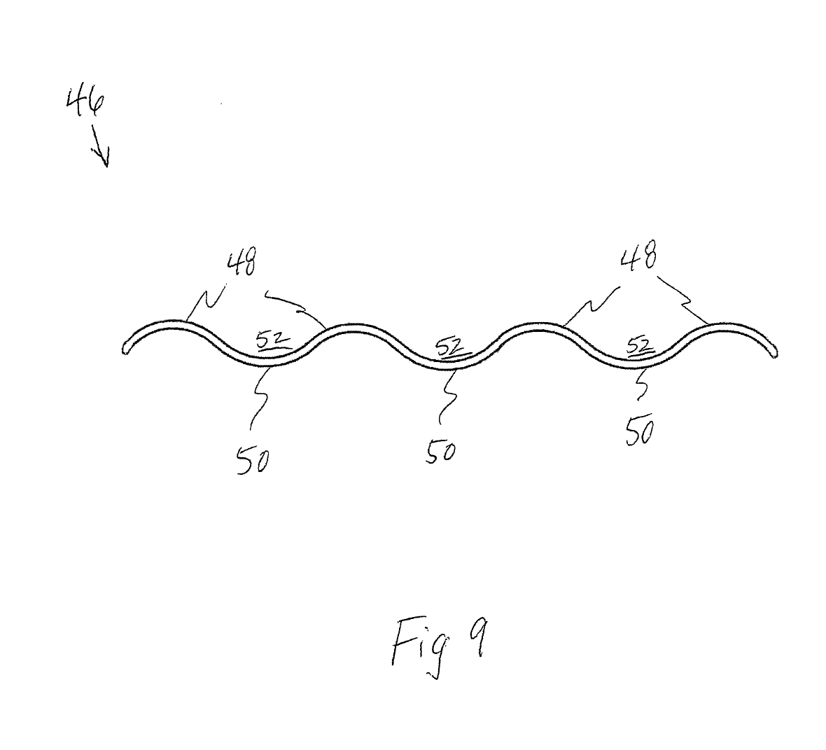

FIG. 9 shows an alternate embodiment of liner securing slot 46. Adjacent slot upper portions 48 have slot lower portions 50 between them, creating tongues 52 to secure a bag handle. A single liner slot may be any length which does not compromise the strength of a surface on which is resides. Each tongue 52 is between at least two upper portions 48, allowing handles to be inserted through a lower portion 50 and pulled into upper portions 48 on each side of tongue 52.

A number of implementations have been described. Nevertheless, it will be understood that additional modifications may be made without departing from the scope of the inventive concepts described herein, and, accordingly, other embodiments are within the scope of the claims that will be made in the non-provisional application.

What is claimed is:

1. A container, comprising:
a container body that has an open top, an upper rim, at least one side, an interior, and an exterior; and
at least two securing slots between the interior and the exterior, each securing slot comprising a parabola shape with a lower portion at its vertex between two upper portions, wherein the upper portions are closer to the upper rim than the lower portion;
wherein each securing slot is opposing another securing slot on the body of the container.

2. The container of claim 1 wherein the upper rim is reinforced.

3. The container of claim 2 further comprising a bottom that is smaller than the open top to allow one container to be nested within another like container.

4. The container of claim 3 wherein adjacent sides are connected between the bottom and the open top of the container creating corners with a corner length.

5. The container of claim 4 wherein most of the corner length protrudes toward the interior of the container.

6. The container of claim 1 further comprising a plurality of opposing securing slots throughout the container body to provide securing locations for bags of various sizes and shapes.

7. The container of claim 1 wherein the upper portions of each securing slot comprise vertices of inverted parabola shapes.

8. The container of claim 7 wherein the parabola and inverted parabolas combine to make a sinewave shaped securing slot, the slot having a lateral length with a center, the length from 2π radians to 3π radians, with the lower portion at the center.

9. The container of claim 7 wherein each slot has a sinewave shape with a length of more than 3π radians and a plurality of upper portions and lower portions.

10. A container, comprising:
a container body that has an open top, a bottom, an upper rim, at least one side, an interior, and an exterior; and
at least two securing slots, each slot comprising:
a lateral length generally aligning with the upper rim and a distance away from the upper rim;
a sinewave-like shape that is from about 2π radians to about 3π radians long;
a least one lower portion; and
at least two upper portions;
wherein the upper portions are closer to the upper rim than the at least one lower portion; and
wherein each lower portion is between at least two upper portions along the lateral length; and
wherein each slot is opposing another slot on the body of the container.
